(19) United States
(12) Patent Application Publication
(10) Pub. No.: US 2024/0325810 A1
(43) Pub. Date: Oct. 3, 2024

(54) FOAM CONCENTRATE TESTING BYPASS SYSTEM

(71) Applicant: Tyco Fire Products LP, Cranston, RI (US)

(72) Inventors: Eric LaVergne, Port Arthur, TX (US); Jordan Nerat, Wallace, MI (US); Andrew Holmio, Menominee, MI (US)

(73) Assignee: Tyco Fire Products LP, Cranston, RI (US)

(21) Appl. No.: 18/579,926

(22) PCT Filed: Oct. 5, 2022
(86) PCT No.: PCT/IB2022/059517

§ 371 Date: Jan. 17, 2024

Related U.S. Application Data
(60) Provisional application No. 63/252,834, filed on Oct. 6, 2021.

(51) Int. Cl. A62C 37/50; A62C 5/02

(52) U.S. Cl. CPC A62C 37/50; A62C 5/02

(57) ABSTRACT

A fire suppression system includes a water line, a foam concentrate line, and a ratio flow controller fluidly coupled to each of the water line and the foam concentrate line at respective first and second inlets. The ratio flow controller controls a ratio of water and foam concentrate within a water and foam solution flowing out of the ratio flow controller. The system also includes a first bypass line fluidly coupled between the water line and the foam concentrate line and a second bypass line fluidly coupled to the foam concentrate line at a third position disposed upstream of the second position. The first bypass line facilitates water flow from the water line at a first position upstream of the first inlet to a second position upstream of the second inlet, and the second bypass facilitates foam concentrate flow from the foam concentrate line into a reservoir.

### CROSS-REFERENCE TO RELATED APPLICATIONS

This application claims priority to U.S. Provisional Patent Application No. 63/252,834, filed Oct. 6, 2021, the entire disclosure of which is incorporated herein by reference in its entirety.

### BACKGROUND

The present disclosure relates generally to fire suppression systems. More specifically, the present disclosure relates to a system and method for testing an amount of fire suppression foam expulsion from a fire suppression system using a bypass.

Generally, pressure balanced fire suppression systems using fire suppression foams must be regularly discharged for predetermined periods of time as part of routine testing. Such routine testing is used to determine and verify a percentage of foam concentrate in a foam solution, which is used to assess safety and readiness of the overall firefighting system.

### SUMMARY

One aspect of the present disclosure relates to a fire suppression system. The system includes a water line providing water from a water supply, a foam concentrate line providing a fire suppressing foam concentrate from a foam concentrate supply, and a ratio flow controller fluidly coupled to each of the water line and the foam concentrate line at respective first and second inlets. The ratio flow controller is configured to control a ratio of a concentration of water and a concentration of foam concentrate within a water and foam solution flowing from an outlet of the ratio flow controller, wherein the second inlet includes a first orifice. The system also includes a first bypass line fluidly coupled between the water line and the foam concentrate line, the first bypass line being configured to facilitate a flow of water from the water line at a first position disposed upstream of the first inlet to a second position disposed upstream of the second inlet. The system further includes a second bypass line fluidly coupled to the foam concentrate line at a third position disposed upstream of the second position, the second bypass being configured to facilitate a flow of foam concentrate from the foam concentrate line through a second orifice into a reservoir. The second orifice has a same diameter as the first orifice.

In various embodiments, the system includes a first isolation valve disposed within the first bypass line, a second isolation valve disposed within the second bypass line, and a third isolation valve disposed upstream of the first position and downstream of the second position. In some embodiments, the flow of water through the first bypass line is metered by the first isolation valve. In other embodiments, the flow of foam concentrate through the second bypass line is metered by the second isolation valve. In yet other embodiments, the third isolation valve is configured to selectively prevent foam concentrate from flowing from the foam concentrate line through the second inlet. In various embodiments, the system further includes a pressure regulating valve disposed within the second bypass line downstream of the second isolation valve and the second orifice, the valve being configured to adjust a pressure of the flow of foam concentrate through the second bypass line. In some embodiments, when a pressure of the valve is substantially equal to a pressure differential across the ratio flow controller, the flow of foam concentrate through the second bypass mimics a flow of the foam concentrate through the second inlet. In various embodiments, the system further includes a pressure regulating valve disposed within the second bypass line downstream of the second isolation valve and the second orifice, the pressure regulating valve being configured to adjust a pressure of the flow of foam concentrate through the second bypass line. In some embodiments, when a differential pressure across the second orifice as regulated by the pressure regulating valve is substantially equal to a pressure differential across the first orifice of the ratio flow controller, the flow of foam concentrate through the second bypass line mimics a flow of the foam concentrate through the second inlet. In other embodiments, the pressure regulating valve is at least one of a diaphragm valve or a globe valve. In yet other embodiments, the foam concentrate is non-fluorinated. In some embodiments, the foam concentrate is fluorinated.

Another aspect of the present disclosure relates to a method of operating a fire suppression system. The method includes providing water from a water supply within a water line, providing a fire suppressing foam concentrate from a foam concentrate supply within a foam concentrate line, and controlling, by a ratio flow controller, a ratio of a concentration of water and a concentration of foam concentrate within a water and foam solution flowing from an outlet of the ratio flow controller. The water line and the foam concentrate line are fluidly coupled to the ratio flow controller at respective first and second inlets. The second inlet includes a first orifice. The method further includes causing a flow of water through a first bypass line fluidly coupled between the water line at a first position disposed upstream of the first inlet and the foam concentrate line at a second position disposed upstream of the second inlet, and causing a flow of the foam concentrate through a second bypass line fluidly coupled to the foam concentrate line at a third position disposed upstream of the second position, wherein the second bypass is configured to facilitate a flow of foam concentrate from the foam concentrate line through a second orifice into a reservoir, the second orifice having a same diameter as the first orifice.

In various implementations, the method also includes opening a pressure regulating valve disposed within the second bypass line downstream of the second isolation valve and the second orifice, wherein opening the valve being adjusts a differential pressure of the flow of foam concentrate through the second orifice within the second bypass line. In some implementations, the method also includes matching the differential pressure of the flow of foam concentrate through the second orifice within the second bypass line to a differential pressure of the first orifice within ratio flow controller. In other implementations, the method also includes determining a flow rate through at least one of the first orifice or the second orifice. In some implementations, determining the flow rate through at least one of the first orifice or the second orifice includes determining a pressure differential across the at least one of the first orifice or the second orifice, determining a pressure factor, and determining the flow rate corresponding to the pressure factor from a reference repository. In various implementations, the pressure factor corresponds to a product of a square root of the pressure differential, an orifice coefficient, a square of a diameter of at least one of the first orifice or the second orifice, and a flow rate constant. In various implementations, the reference repository includes at least one set of reference curves. In some implementations, the at least one set of reference includes comprises a first set of reference curves corresponding to a permanent pressure loss and a second set of reference curves corresponding to a metered pressure drop.

Yet another aspect of the present disclosure relates to a method of determining a flow rate through an orifice within a fire suppression system. The method includes determining a pressure differential across the orifice, determining a pressure factor, and determining the flow rate corresponding to the pressure factor from a reference repository. The pressure factor corresponds to the pressure differential. In various embodiments, the fire suppression system includes a water line providing water from a water supply, and a foam concentrate line providing a fire suppressing foam concentrate from a foam concentrate supply. The system also includes a ratio flow controller fluidly coupled to each of the water line and the foam concentrate line at respective first and second inlets, the ratio flow controller configured to control a ratio of a concentration of water and a concentration of foam concentrate within a water and foam solution flowing from an outlet of the ratio flow controller, wherein the second inlet comprises the orifice. The system also includes a first bypass line fluidly coupled between the water line and the foam concentrate line, the first bypass line configured to facilitate a flow of water from the water line at a first position disposed upstream of the first inlet to a second position disposed upstream of the second inlet.

In various implementations, the pressure differential corresponds to at least one of a permanent pressure loss or a metered pressure drop. In some implementations, the flow rate constant is 29.83 and the orifice coefficient is 0.62, and each of the flow rate constant and the orifice coefficient are determined from at least one look-up table.

This summary is illustrative only and should not be regarded as limiting.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic representation of a fire suppression system including foam concentrate.

FIG. 2 is a schematic representation of a fire suppression system with a foam concentrate bypass, according to an exemplary embodiment.

FIG. 3 is a schematic representation of a fire suppression system with a foam concentrate bypass, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

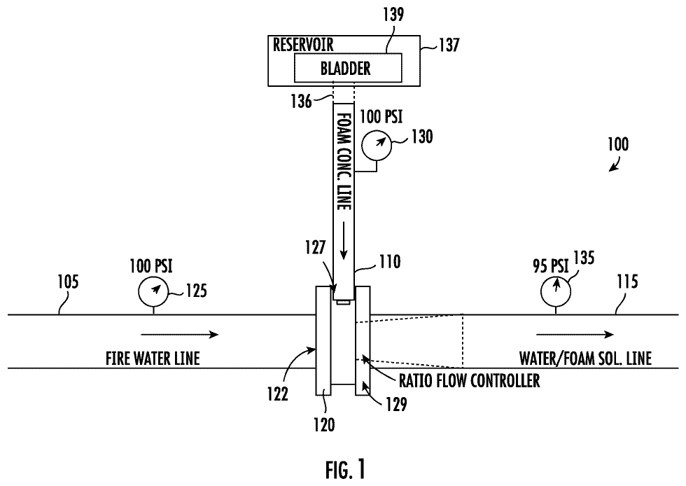

Referring to FIG. 1, a fire extinguishing or suppression system 100 is shown. The system 100 is configured to address (e.g., extinguish, suppress, etc.) one or more fires within, on, or nearby a structure or area (e.g., building, residence, storage unit, etc.) within which the system 100 is located. The system 100 may be a balanced pressure foam system that mixes foam concentrate (e.g., fluorinated or non-fluorinated foam concentrate) with a flow of water to produce a water and foam solution, which may be discharged by the system 100 to address one or more fires. As shown, the system 100 includes a water line 105, which is fluidly connected with a foam concentrate line 110 and a water/foam solution line 115 via ratio flow controller 120. The water line 105 receives water from a water supply (e.g., water supply conduits within the structure, a water reservoir, etc.). The ratio flow controller 120, which receives water from the water line 105 at a water inlet 122 and receives foam concentrate through a foam inlet 127, is configured to meter at least one of an amount of water through the water inlet 122 or an amount of foam concentrate through the foam inlet 127 to expel a water/foam solution through an outlet 129 having a known or predetermined water and foam ratio. Although, ratio flow controllers are typically designed to minimize a drop in pressure between inlets thereto and outlets therefrom, in most cases, there is a non-zero pressure drop between the inlets and outlets. Accordingly, in the system 100, the water line 105 is fluidly coupled to at least one pressure sensor or gauge 125 configured to measure a pressure of water within the water line 105, the foam line is fluidly coupled to at least one pressure sensor or gauge 130 configured to measure a pressure of foam concentrate within the foam line 110, and the water/foam solution line 115 is coupled to a pressure sensor or gauge 135 configured to measure of a pressure of water/foam solution within the water/foam solution line 115. For example, as shown in FIG. 1, the ratio flow controller 120 may cause a 5 pounds per square inch (psi) pressure drop between the inlet 122 and the outlet 129, and a 5 psi pressure drop between the inlet 127 and the outlet 129, as both the pressure gauges 125 and 130 read a pressure of 100 psi and the pressure gauge 135 reads a pressure of 95 psi. In various implementations the pressure drop across ratio flow controller 120 may increase or decrease based on at least one of a flow through the water inlet 122 or the foam inlet 127. In various embodiments, the system 100 may include more or fewer pressure sensor gauges. For example, the system 100 may be designed to operate without pressure gauges 125, 130, and/or 135.

As described above, the system 100 may be a balanced pressure foam system. Accordingly, foam concentrate through the foam line 110 may be driven by a pump or a bladder tank fluidly coupled to the foam line 110. It should be noted that although FIG. 1 depicts a bladder tank, any pressure balance system may be implemented within the system 100. For example, a foam concentrate reservoir 137 (e.g., tank) may be fluidly coupled to the foam line 110, where flow of the foam concentrate from the reservoir is controlled by a pump 136 configured to discharge the foam concentrate into the foam line 115. In various implementations, the foam line 110 may be fluidly coupled to a return line that returns excess foam concentrate from within the foam line 110 (i.e., foam concentrate in excess of the predetermined ratio set by the ratio flow controller 120) to the reservoir 137, such as in configurations where the pump 136 is designed to provide a constant volume and pressure of foam concentrate regardless of a demand of the system 100. In some implementations, a diaphragm valve may be fluidly coupled within the foam line 110 to control flow of foam concentrate from the reservoir 137 to the foam inlet 127 and/or the return line back to the reservoir 137.

In yet other implementations, the reservoir 137 may include a bladder 139 or other compressible containment structure disposed within the reservoir 137, where the bladder 139 is configured to store foam concentrate therein. The bladder 139 may be suspended within the reservoir 137 and surrounded by water in a spaced disposed between the bladder 139 and an inner wall of the reservoir 137. The water within the reservoir 137 may be received from a water source fluidly coupled to the water line 105 such that as the system 100 operates, water from the water line 105 (or from a conduit connected therewith) flows into the space between the bladder 139 and the reservoir 137, thereby forcing foam concentrate from within the bladder 139 into the foam line 110.

Flow through the system 100, and thus a concentration of the water/foam solution through the water/foam solution line 115 may be, at least in part, based on at least one of a diameter of the ratio flow controller 120 outlet 129. For example, the ratio flow controller 120 may have a 4 inch diameter, which allows for approximately 750 gallons per minute (gpm) of flow through the water/foam solution line 115. If the ratio flow controller 120 causes a pressure drop of 5 psi, the system 100 may be controlled such that a flow through the foam line 110 is 22.5 gpm, which results in the water/foam solution within the line 115 having approximately 3% foam concentrate by volume.

As described above, with certain fire suppression systems using foam concentrate, such as system 100, water/foam solution expelled from an outlet end of the water/foam solution line 115 is dispersed in an area within which the system 100 is disposed to suppress or extinguish one or more fires within the area. Although generally effective during a fire emergency, operating such a system 100 during test conditions (e.g., to verify an amount of water/foam solution being expelled by the system 100) results in large amounts of water/foam solution being consumed, which can be costly.

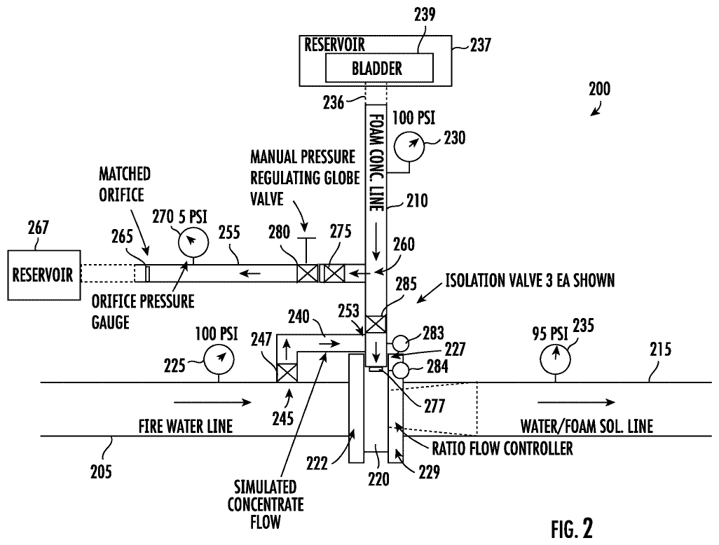

Accordingly, a fire suppression system may be fitted (e.g., fitted during manufacture or retrofitted) with a bypass mechanism to facilitate capture and/or recirculation of foam concentrate, water, and/or water/foam solution. FIG. 2 shows a fire suppression system 200, which includes a bypass mechanism, according to an exemplary embodiment. In various embodiments, elements 205-239 of the system 200 are similar or equivalent to the elements 105-139 of the system 100, respectively. As shown in FIG. 2, the system 200 includes a first bypass line 240, which is fluidly coupled between the water line 205 at a position 245 disposed upstream of the inlet 222, and the foam line 210 at a position 253 disposed upstream of the inlet 227. The first bypass line 240 may be a pipe or conduit, which is configured to enable a portion of water within the water line 205 to flow upstream of the inlet 227 and into the ratio flow controller 220. Flow within the first bypass line 240 may be controlled by an isolation valve 247, which may be mechanically, electronically, or hydraulically operated. A second bypass line 255, which also may be a pipe or conduit, is fluidly coupled to the foam line 210 at a position 260 disposed upstream of the position 253. The second bypass line 255 is configured to enable foam concentrate flowing within the foam line 210 to bypass the ratio flow controller 220 and instead flow through an orifice 265 and into a collection receptacle or reservoir 267. Flow into the second bypass line 255 may be controlled by an isolation valve 275, which may be mechanically, electronically, or hydraulically operated. To prevent foam concentrate from flowing into the ratio flow controller 220, an isolation valve 285 may be fluidly coupled within the foam line 210 upstream of the position 253 (i.e., where the first bypass 240 is connected to the foam line 210) and downstream of the position 275 (i.e., where the second bypass 255 is connected to the foam line 210).

In various embodiments, the isolation valves 247, 275, and 285 may operate cooperatively such that the system 200 may alternate among three modes: a suppression mode, a bypass mode, and an off mode. During the suppression mode, the isolation valve 285 is in an open configuration while the isolation valves 274 and 275 are in a closed configuration. These configurations allows foam concentrate from the foam line 210 to flow into the ratio flow controller 220 at the inlet 227 and mix with water flowing through the inlet 222 from the water line 205, which then results in a water/foam solution to flow from the outlet 229 through the water/foam solution line 215. During the off mode, each of the isolation valves 247, 275, and 285 may be in a closed configuration to prevent foam concentrate from flowing through the system 200. During the bypass mode, the isolation valves 247 and 275 may be in an open configuration while the isolation valve 285 is in a closed configuration. These configurations then force a portion of water from the water line through the first bypass 240 and divert foam concentrate from the foam line 210 to the second bypass 255.

In various embodiments, the bypass mode may be used to test operation of the system 200. For example, the bypass mode may be used to determine an amount and/or flow rate of at least one of foam concentrate or water/foam solution circulated by the system 200. Accordingly, in the bypass mode, foam concentrate from the foam line 210 may be preserved or collected within the reservoir 267 rather than being irreversibly expelled from the system 200. to determine the amount and/or flow rate of at least one of the foam concentrate or water/foam solution without directing foam concentrate to flow through the ratio flow controller 320, the second bypass 355 may be fluidly connected to a pressure regulating valve 380, which may be configured to control a pressure within the second bypass line 355, where a pressure differential across the orifice 265 may be measured or determined by a pressure sensor or gauge 270. Similarly, a pressure differential across the orifice 277 may be measured or determined (e.g., by pressure sensors 283 and 284). The orifice 265, which is disposed downstream of the pressure regulating valve 280, may be dimensionally matched (e.g., having a same diameter) to an orifice 277 disposed within the inlet 227. As shown, the valve 280 is disposed upstream of the orifice 265. In other embodiments, the valve 280 may be substituted with a diaphragm valve. Accordingly, the valve 280 may be adjusted to control the pressure within the second bypass line 255 to be substantially the same as the pressure drop across the ratio flow controller (e.g., 5 psi as in the example described previously). When the pressure in the bypass line 255 is equivalent to the pressure drop across the ratio flow controller 220, an amount of foam concentrate collected within the reservoir 267 is equivalent to an amount of foam concentrate that would be expelled by the system 200 during the suppression mode. In various embodiments, the system 200 may be operated in the bypass mode for a predetermined period of time (e.g., 15 sec, 30 sec, 45 sec, 60 sec, 120 sec, etc.). In various embodiments, the predetermined period of time may be based on a dimeter of at least one of the inlet 222, the inlet 227, or the orifice 265. Foam concentrate collected within the reservoir 267 during the predetermined period of time may then be weighed or otherwise measured to determine an amount and/or flow rate of foam concentrate circulated or expelled during system 200 operation without irreversibly consuming foam concentrate in the process.

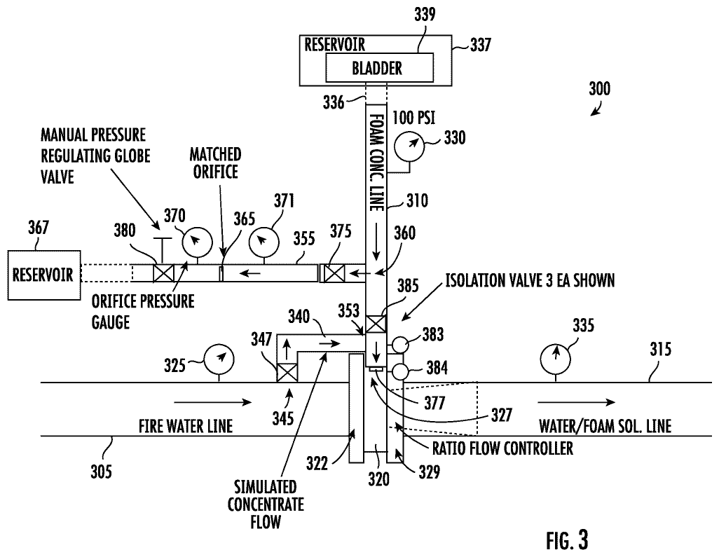

FIG. 3 shows a fire suppression system 300, which includes a bypass mechanism, according to an exemplary embodiment. In various embodiments, elements 305-385 of the system 300 are similar or equivalent to the elements 205-285 of the system 200, respectively. As shown in FIG. 3, the system 300 includes a first bypass line 340 and a second bypass line 355.

With the system 300, as in the system 200, to determine the amount and/or flow rate of at least one of the foam concentrate or water/foam solution without directing foam concentrate to flow through the ratio flow controller 320, the second bypass 355 may be fluidly connected to a pressure regulating valve 380, which may be configured to control a pressure within the second bypass line 355, where a pressure differential across the orifice 365 may be measured or determined by pressure sensors or gauges 370 and 371. Similarly, a pressure differential across the orifice 377 may be measured or determined by pressure sensors 383 and 384. The orifice 365, which is disposed upstream of the pressure regulating valve 380, may be dimensionally matched (e.g., having a same diameter) to the orifice 377 disposed within the inlet 327. In some embodiments, the valve 380 may be a globe valve or a diaphragm valve. Accordingly, the valve 380 may be adjusted to control the pressure within the second bypass line 355 to be substantially the same as the pressure drop across the orifice 377 within the ratio flow controller 320 (e.g., 5 psi). When the pressure in the bypass line 355 is equivalent to the pressure drop across orifice 377 within the ratio flow controller 320, an amount of foam concentrate collected within the reservoir 367 is equivalent to an amount of foam concentrate that would be expelled by the system 300 during the suppression mode. In various embodiments, the system 300 may be operated in the bypass mode for a predetermined period of time (e.g., 15 sec, 30 sec, 45 sec, 60 sec, 120 sec, etc.). In various embodiments, the predetermined period of time may be based on a dimeter of at least one of the inlet 322, the inlet 327, or the orifice 365. Foam concentrate collected within the reservoir 367 during the predetermined period of time may then be weighed or otherwise measured to determine an amount and/or flow rate of foam concentrate circulated or expelled during system 300 operation without irreversibly consuming foam concentrate in the process.

Operation of the systems 200 and/or 300 during the bypass mode may also be validated mathematically using Equation 1, in which D is an orifice diameter, Q is a flow rate in gallons per minute, C is an orifice coefficient, and P is a conduit pressure. Accordingly, flow of foam concentrate through the second bypass 255 or 355 can be determined by rearranging Equation 1 for Q, and using the diameter of the orifice 265 or 365 (which is matched to the orifice at the inlet 227 or 377), the pressure determined by the pressure gauge 270 or 370 (as controlled by the pressure regulating valve 280 or 380), using an appropriate orifice coefficient (e.g., 0.61 for a square orifice).

$$D = \sqrt{\frac{Q}{29.85 \times C \times \sqrt{P}}} \qquad Equation 1$$

Similarly, to determine the pressure within the second bypass 255 or 355, or to estimate the pressure drop across the orifice 277 or 377 within the ratio flow controller 220 or 320, Equation 1 may be rearranged based on known values for D, Q, and C, and solving for P.

In various implementations, the systems 200 and/or 300 may be used to determine (e.g., estimate, calculate, etc.) flow between a water line (e.g., lines 205, 305) and a water/foam solution line (e.g., lines 215, 315). In various implementations, the flow can be determined using at least one of a permanent pressure drop, which may be determined between the pressure sensor or gauge disposed within or coupled to the water line (i.e., by the pressure sensor or gauge 225, 325) and the pressure sensor or gauge disposed within or coupled to the water/foam solution line (i.e., by the pressure sensor or gauge 235, 335). In other implementations, the flow can be determined using a metered pressure drop (i.e., pressure differential) determined across an orifice (e.g., orifice 277, 377) within a ratio flow controller (e.g., controller 220, 320) by pressure sensor or gauges disposed on either side of the orifice (e.g., pressure sensor or gauge 283, 284, 383, 384). Without or without pressure sensor or gauges, Equation 2 can also be used to determine pressure drop or pressure factor, which can then be used to determine flow rate.

$$Pressure factor = 29.83 \times {D}^{2} \times X \times √ P \qquad Equation 2$$

In Equation 2, 29.83 is a known constant related to flow rate (determinable from one or more known reference repositories, such a look-up table or database), D is orifice diameter (in inches), C is the orifice coefficient (determinable from one or more known reference repositories, such a look-up table or database), and P is the pressure is a conduit pressure. Accordingly, a pressure factor determined from Equation 2 can be used to determine a flow rate across the orifice (e.g., orifice 277, 377) from a reference repository (e.g., look-up table, database, reference curve, etc.). In some embodiments, the flow rate is determined in gallons per minute. In some embodiments, the flow rate is determine from one of two sets of reference curves, where a first set of reference curves relates flow rate to a permanent pressure drop across the orifice (e.g., orifice 277, 377) and a second set of reference curves relates flow rate to a metered pressure drop across the orifice (e.g., orifice 277, 377). In some embodiments, the orifice coefficient is 0.62. In some embodiments, the orifice diameter is 0.707 in. In various embodiments, the system 200 and/or 300 may be in communication with one or more controllers, the one or more controllers being configured to determine flow rate based on one or more inputs from a coupled database and/or one or more inputs received from the pressure sensor or gauges disposed on either side of the orifice (e.g., pressure sensor or gauge 283, 284, 383, 384).

Thus, to determine an amount or flow rate of foam concentrate (or water/foam solution) that would be expelled by the system 200, 300 during the suppression mode, the system 200, 300 may instead be operated in the bypass mode, where foam concentrate is retained within the system 200, 300, thereby preventing excess waste and costs associated with foam concentrate consumption. During operation of the system 200, 300 in the bypass mode, the foam line 210, 310 may be isolated via the isolation valve 285, 385, to fluidly seal the foam line 210, 310 from the ratio flow controller 220, 320. Next, the isolation valve 275, 375 within the second bypass line 255, 355 and the isolation valve 247, 347 within the first bypass line 240, 340 may be opened. After the isolation valve 285, 385 is closed and the valves 247, 347 and 275, 375 are opened, water flow through the water line 205, 305 may be enabled and a portion of the water within the water line 205, 305 may also flow through the first bypass 240, 340. In a subsequent operation, foam concentrate from the reservoir 237, 337 may be initiated (e.g., via the pump 236, 336 and/or via the bladder 239, 339) to flow from the foam line 210, 310 into the second bypass line 255, 355. The valve 280, 380 may then be gradually opened until the differential pressure measured by the pressure gauge 270, 370 is substantially equal to the differential pressure measured by the gauges 283, 284, 383, 384 across the orifice 277, 377 within the ratio flow controller 220, 320. Foam concentrate flowing from the second bypass line 255, 355 is then collected within the reservoir 267, 367 for a predetermined period of time (i.e., 15 sec, 30 sec, 45 sec, 60, sec, 120 sec) based on one or more parameters of the system 200, 300 (e.g., a dimension of the inlets 222, 227, 322, 327, or a dimension of the orifice 265, 365). After the predetermined period of time, the amount of foam concentrate collected within the reservoir 267, 367 may be weighed or otherwise measured to determine amount or flow rate (e.g., in gpm) of the foam concentrate through the system 200, 300.

In various embodiments, the system 200, 300 may include or be communicatively coupled to one or more controllers. The one or more controllers may be operably coupled to at least one of the pressure regulating valve 280, 380, the isolation valve 247, 347, the isolation valve 275, 375, or the isolation valve 285, 385, where the one or more controllers may be configured to control operation of said valves and, thus, control operation of the system 200, 300 within the suppression, bypass, and off modes.

Notwithstanding the embodiments described above in reference to FIGS. 1-3, various modifications and inclusions to those embodiments are contemplated and considered within the scope of the present disclosure.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A fire suppression system, the system comprising:
a water line providing water from a water supply;
a foam concentrate line providing a fire suppressing foam concentrate from a foam concentrate supply;
a ratio flow controller fluidly coupled to each of the water line and the foam concentrate line at respective first and second inlets, the ratio flow controller configured to control a ratio of a concentration of water and a concentration of foam concentrate within a water and foam solution flowing from an outlet of the ratio flow controller, wherein the second inlet comprises a first orifice;
a first bypass line fluidly coupled between the water line and the foam concentrate line, the first bypass line configured to facilitate a flow of water from the water line at a first position disposed upstream of the first inlet to a second position disposed upstream of the second inlet; and
a second bypass line fluidly coupled to the foam concentrate line at a third position disposed upstream of the second position, the second bypass line configured to facilitate a flow of foam concentrate from the foam concentrate line through a second orifice into a reservoir, the second orifice having a same diameter as the first orifice.

2. The system of claim 1, further comprising:
a first isolation valve disposed within the first bypass line;
a second isolation valve disposed within the second bypass line; and
a third isolation valve disposed upstream of the first position and downstream of the second position.

3. The system of claim 2, wherein the flow of water through the first bypass line is metered by the first isolation valve.

4. The system of claim 2, wherein the flow of foam concentrate through the second bypass line is metered by the second isolation valve.

5. The system of claim 2, wherein the third isolation valve is configured to selectively prevent foam concentrate from flowing from the foam concentrate line through the second inlet.

6. The system of claim 2, further comprising a pressure regulating valve disposed within the second bypass line downstream of the second isolation valve and the second orifice, the pressure regulating valve being configured to adjust a pressure of the flow of foam concentrate through the second bypass line.

7. The system of claim 6, wherein when a differential pressure across the second orifice as regulated by the pressure regulating valve is substantially equal to a pressure differential across the first orifice of the ratio flow controller, the flow of foam concentrate through the second bypass line mimics a flow of the foam concentrate through the second inlet.

8. The system of claim 2, wherein the pressure regulating valve is at least one of a diaphragm valve or a globe valve.

9. The system of claim 1, wherein the foam concentrate is non-fluorinated.

10. The system of claim 1, wherein the foam concentrate is fluorinated.

11. A method of operating a fire suppression system, the method comprising:
providing water from a water supply within a water line;
providing a fire suppressing foam concentrate from a foam concentrate supply within a foam concentrate line;
providing a ratio flow controller, the ratio flow controller configured to control a ratio of a concentration of water and a concentration of foam concentrate within a water and foam solution flowing from an outlet of the ratio flow controller, wherein the water line and the foam concentrate line are fluidly coupled to the ratio flow controller at respective first and second inlets, and wherein the second inlet comprises a first orifice;
causing a flow of water through a first bypass line fluidly coupled between the water line at a first position disposed upstream of the first inlet and the foam concentrate line at a second position disposed upstream of the second inlet; and
causing a flow of the foam concentrate through a second bypass line fluidly coupled to the foam concentrate line at a third position disposed upstream of the second position, wherein the second bypass line is configured to facilitate a flow of foam concentrate from the foam concentrate line through a second orifice into a reservoir, the second orifice having a same diameter as the first orifice.

12. The method of claim 11, further comprising opening a pressure regulating valve disposed within the second bypass line downstream of both the second orifice and an isolation valve within disposed within the second bypass line, wherein opening the pressure regulating valve adjusts a differential pressure of the flow of foam concentrate through the second orifice within the second bypass line.

13. The method of claim 12, further comprising matching the differential pressure of the flow of foam concentrate through the second orifice within the second bypass line to a differential pressure across the first orifice within the ratio flow controller.

14. The method of claim 11, further comprising determining a flow rate through at least one of the first orifice or the second orifice.

15. The method of claim 14, wherein determining the flow rate through at least one of the first orifice or the second orifice comprises:
determining a pressure differential across the at least one of the first orifice or the second orifice;
determining a pressure factor, the pressure factor corresponding to a product of a square root of the pressure differential, an orifice coefficient, a square of a diameter of at least one of the first orifice or the second orifice, and a flow rate constant;
determining the flow rate corresponding to the pressure factor from a reference repository.

16. The method of claim 15, wherein the reference repository comprises at least one set of reference curves.

17. The method of claim 16, wherein the at least one set of reference curves comprises a first set of reference curves corresponding to a permanent pressure loss and a second set of reference curves corresponding to a metered pressure drop.

18. A method of determining a flow rate through an orifice within a fire suppression system, the method comprising:
determining a pressure differential across the orifice;
determining a pressure factor, based on the pressure differential; and
determining the flow rate corresponding to the pressure factor from a reference repository;
wherein the fire suppression system comprises:
a water line providing water from a water supply;
a foam concentrate line providing a fire suppressing foam concentrate from a foam concentrate supply;
a ratio flow controller fluidly coupled to each of the water line and the foam concentrate line at respective first and second inlets, the ratio flow controller configured to control a ratio of a concentration of water and a concentration of foam concentrate within a water and foam solution flowing from an outlet of the ratio flow controller, wherein the second inlet comprises the orifice; and
a first bypass line fluidly coupled between the water line and the foam concentrate line, the first bypass line configured to facilitate a flow of water from the water line at a first position disposed upstream of the first inlet to a second position disposed upstream of the second inlet.

19. The method of claim 18, wherein the pressure differential corresponds to at least one of a permanent pressure loss or a metered pressure drop.

20. The method of claim 18, wherein the flow rate constant is 29.83 and the orifice coefficient is 0.62, and wherein each of the flow rate constant and the orifice coefficient are determined from at least one look-up table.
